(19) United States
(12) Patent Application Publication
(10) Pub. No.: US 2014/0114765 A1
(43) Pub. Date: Apr. 24, 2014

(54) SYSTEM FOR PROVIDING AN ADVERTISEMENT AMONG TERMINALS

(71) Applicant: Sang Hoon Lee, Gyeonggi-do (KR)

(72) Inventor: Sang Hoon Lee, Gyeonggi-do (KR)

(73) Assignees: Sang Hoon, Gyeonggi-do (KR); AQ CO., LTD., Seoul (KR)

(21) Appl. No.: 14/007,414

(22) PCT Filed: Oct. 19, 2011
(86) PCT No.: PCT/KR2011/007808

§ 371 Date: Dec. 9, 2013

(30) Foreign Application Priority Data
Mar. 25, 2011 (KR) 10-2011-0027012

(51) Int. Cl. G06Q 30/02; H04W 76/02

(52) U.S. Cl. CPC G06Q 30/0267; H04W 76/02
USPC 705/14.64

(57) ABSTRACT

The present invention has the purpose of providing a system for transmitting an advertisement among terminals to only a user interested in a product by using the method of near-field communication. To achieve this, provided is a terminal that provides an advertisement among terminals, including: an advertisement data storage unit; a near-field communication unit transmitting and receiving advertisement data stored in another terminal and the advertisement data storage unit; a server communication unit communicating with an advertisement server; and a control unit processing the advertisement data in order to include a user's own terminal information when transmitting the advertisement data to another terminal, and transmitting advertisement identification information, terminal information for transmitting the advertisement data, and the user's own terminal information to the advertisement server through the server communication unit after watching the advertisement when receiving the advertisement data to watch.

### CROSS REFERENCE TO RELATED APPLICATIONS AND CLAIM OF PRIORITY

This patent application is a National Phase application under 35 U.S.C. §371 of International Application No. PCT/KR2011/00780, filed 19 Oct. 2011, which claims priority to Korean Patent Application No. 10-2011-0027012 filed 25 Mar. 2011, entire contents of which are incorporated herein by reference.

### BACKGROUND

1. Field of the Invention

The present invention relates to a system for providing advertisements between terminals, which transmits/receives an advertisement between terminals using short-range communication, and provides advertisement points to the corresponding terminal depending on a received advertisement.

2. Description of the Related Art

Modern society is an industrial society in which mass production and mass consumption of products are conducted, and different brand-name products for the same item come to market. Therefore, from the standpoint of product manufacturers, how products are to be advertised to consumers is as important as which products are to be manufactured.

When products are advertised, advertising using mass media is advantageous because products can be exposed to a large number of unspecified people, but advertising efficiency is suboptimal because advertisements are equally exposed to people who are not interested in the specific product. Therefore, from the standpoint of advertising efficiency, it is important to provide advertisements to people interested in the specific product.

Recently, information communication devices, such as mobile phones, have become a necessity for everyone. Mobile phones may be used as an advertisement delivery medium in that it can always be carried. However, at the present time, most advertisements using mobile phones are also provided to unspecified individuals and unwarranted. As example of such an unwarranted advertisement, spam messages, such as loan information, may be presented. Furthermore, there is a disadvantage in that when a user receives a large capacity advertisement, such as a video advertisement using a mobile phone, high communication fees are required.

Accordingly, the present invention has been made in light of the above problems occurring in the prior art, and the present invention provides a system and method for providing an advertisement between terminals, with respect to users interested in a product, using a short-range communication scheme.

The present invention also provides points, based on the viewing of an advertisement, to all users who use the advertisement upon providing the advertisement between terminals.

The present invention will be easily understood by the description of the following embodiments.

### SUMMARY

In accordance with an aspect of the present invention, there is provided a terminal for providing an advertisement between terminals, including an advertisement data storage unit, a short-range communication unit for transmitting/receiving advertisement data stored in the advertisement data storage unit to/from other terminals, a server communication unit for communicating with an advertisement server, and a terminal control unit for, when advertisement data is transmitted to other terminals, processing the advertisement data so that its own terminal information is included in the advertisement data, and for when advertisement data is received and viewed, transmitting advertisement identification information, information about a terminal which transmitted the advertisement data, and its own terminal information to the advertisement server through the server communication unit after the advertisement has been viewed.

The short-range communication unit may use one or more of Near Field Communication (NFC), Bluetooth, Zigbee, and Ultra-Wideband (UWB) communication schemes.

When the terminal is a smart phone, the terminal may directly receive advertisement point information from the advertisement server, whereas when the terminal is a feature phone, the terminal may receive the advertisement point information from a message provision server in a form of a text message or a multimedia message.

Furthermore, there is provided a server for providing an advertisement between terminals, including a communication unit for communicating with terminals or a message server, an advertisement viewing information collection unit for collecting advertisement viewing information from pieces of information received from the terminals, an advertisement point information storage unit for storing pieces of advertisement point information of the respective terminals, and a control unit for performing control such that the advertisement point information is upgraded using the advertisement viewing information collected by the advertisement viewing information collection unit and is stored in the advertisement point information storage unit, and the stored advertisement point information is transmitted to the terminals or the message server.

The advertisement viewing information may include advertisement identification information, information about a terminal that provided the advertisement, and information about a terminal on which the advertisement was viewed.

The advertisement point information storage unit may store cumulative advertisement points of respective terminals in the form of a table such that, for corresponding advertisement identification information, a terminal which provided an advertisement matches a terminal which received the advertisement and on which the advertisement was viewed.

Furthermore, there is provided a system for providing an advertisement between terminals, including a plurality of terminals for transmitting/receiving advertisement data between terminals using short-range communication, allowing an advertisement to be viewed, and transmitting advertisement viewing information to an advertisement server after the advertisement has been viewed, and an advertisement server for receiving the advertisement viewing information from the terminals, analyzing the advertisement viewing information, and allocating advertisement points to respective terminals.

The terminals may be configured to, when the advertisement data is transmitted to a subsequent terminal, transmit the advertisement data after its own terminal information has been included in the advertisement data.

The advertisement viewing information may include advertisement identification information, information about a terminal which provided the advertisement, and information about a terminal on which the advertisement was viewed.

The advertisement server may analyze the advertisement viewing information, allocate advertisement points to the respective terminals, and provide advertisement point information to the terminals.

The system may further include a message server for receiving the advertisement points from the advertisement server, and transmitting advertisement point information including the advertisement points to the terminals in a form of a text message or a multimedia message.

In accordance with the present invention, advertisement points based on the viewing of an advertisement are provided to users who viewed the advertisement and to users who provided the advertisement, thus encouraging people to view more advertisements.

Furthermore, there is an advantage in that advertisement points based on the viewing of an advertisement are provided to users, thus allowing the users to check their advertisement points immediately when viewing the advertisement.

### BRIEF DESCRIPTION OF THE DRAWINGS

FIG. 1 is a diagram showing a process for transmitting advertisement data between terminals according to an embodiment of the present invention;

FIG. 2 is a diagram showing the notification of advertisement viewing information and point provisions between individual terminals and an advertisement server according to an embodiment of the present invention;

FIG. 3 is a diagram showing the provision of advertisement point information from a message server to individual terminals according to an embodiment of the present invention;

FIG. 4 is a diagram showing the configuration of a terminal according to an embodiment of the present invention;

FIG. 5 and FIG. 6 are diagrams showing the format of transmitted advertisement data when a terminal transmits the advertisement data to another terminal according to an embodiment of the present invention;

FIG. 7 and FIG. 8 are diagrams showing the data format of advertisement viewing information transmitted from a terminal to an advertisement server according to an embodiment of the present invention;

FIG. 9 is a diagram showing the configuration of an advertisement server according to an embodiment of the present invention;

FIG. 10 is a diagram showing a method of providing an advertisement between terminals according to an embodiment of the present invention; and

FIG. 11 is a diagram showing a method of providing advertisement point information from a message server to terminals according to an embodiment of the present invention.

### DETAILED DESCRIPTION

The present invention may be modified in various ways and may have various embodiments. Specific embodiments will be illustrated in the attached drawings and described in detail below. However, the present invention is not intended to be limited by the described specific embodiments, and it should be understood that the present invention includes all modifications, equivalents or substitutes within the spirit and scope of the present invention.

The terms used in the present invention are merely used to describe specific embodiments and are not intended to limit the present invention. A singular expression includes plural expressions unless a description to the contrary is specifically pointed out in context.

Since the present invention mainly uses a Near Field Communication (NFC) scheme among short-range communication schemes, the NFC scheme will be described briefly prior to the detailed description of the invention.

The NFC scheme is one of the short-range communication schemes, and denotes a contactless short-range wireless communication that uses a frequency of 13.56 MHz. NFC enables a data transmission function, a payment function, and a security function between terminals via tagging between the terminals within a very short-range of 10 cm or less. Here, tagging denotes access or contact required to mutually transfer data between terminals.

NFC is generally operated in the following three modes.

First, NFC is operated in a reader/writer mode. The reader/writer mode is a mode in which information is written and written information is read. Therefore, in this mode, functions such as a barcode and a barcode scanner for reading the barcode may be performed.

Second, NFC is operated in a peer-to-peer mode. The peer-to-peer mode is a mode in which information may be exchanged between devices. Therefore, in this mode, data may be transmitted/received between terminals.

Third, NFC is operated in a card emulation mode. The card emulation mode is a mode that allows a mobile phone to function as a transportation card and to perform other payment functions.

Therefore, NFC is a communication scheme that is operated with a frequency band of 13.56 MHz and enables both the reading and writing of data to be performed, and allows data communication between terminals to be performed at a rate of 424 Kbits per second, and has a payment function to enable products to be purchased via authentication.

Therefore, various utilization purposes of NFC technology may enable functions, such as reserving transportation tickets using a mobile phone, exchanging information between mobile phones, obtaining information about performance through a tag (i.e., smart chip) contained in a performance poster, and performing financial payments using a credit card or the like.

Hereinafter, embodiments of the present invention will be described in detail with reference to the attached drawings.

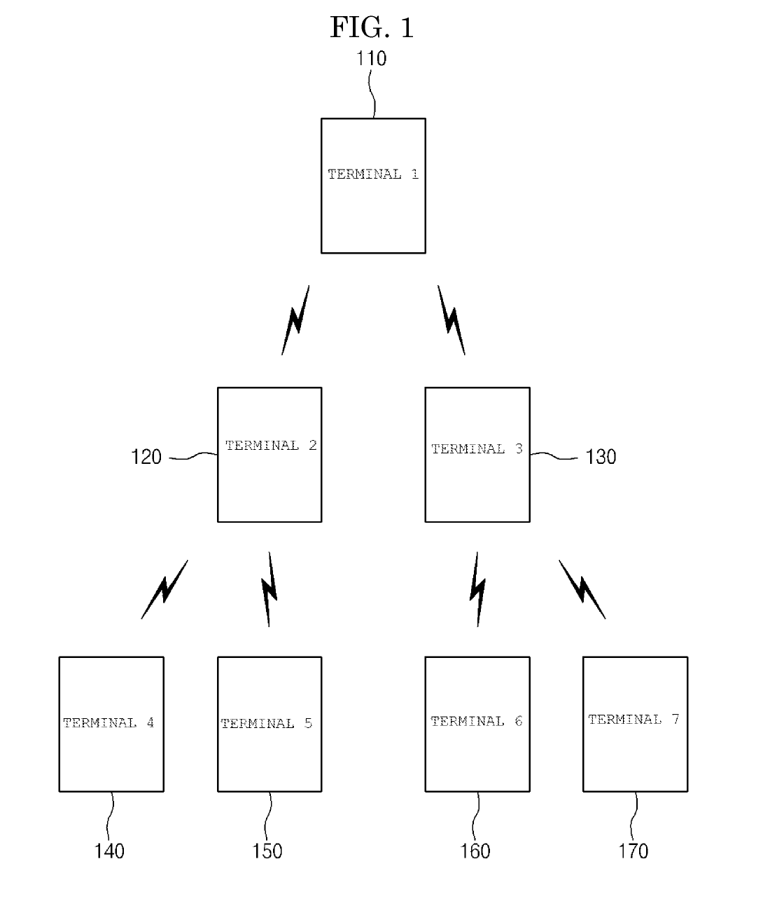

FIG. 1 is a diagram showing a process for transmitting advertisement data between terminals according to an embodiment of the present invention.

Individual terminals (110), (120), (130), (140), (150), (160), and (170) may transmit advertisements between them using short-range communication.

Each terminal that receives an advertisement is provided with advertisement points based on the viewing of the corresponding advertisement after the advertisement has been viewed. Furthermore, when the corresponding advertisement is viewed on the terminal that receives the advertisement, a terminal that provided the advertisement is also provided with advertisement points.

For example, assuming that 100 points are to be provided when the advertisement is directly viewed, and a terminal that previously provided the advertisement is to be provided with 50% of the points, if the corresponding advertisement is viewed on Terminal 5 (150), Terminal 5 (150) is provided with 100 points because the advertisement is directly viewed thereon. Terminal 2 (120), which provided the advertisement to Terminal 5 (150) is provided with 50 points, corresponding to 50% of the 100 points. Furthermore, since Terminal 1 (110) provided the advertisement viewed on Terminal 5 (150) to Terminal 2 (120), Terminal 1 (110) is provided with 25 points corresponding to 50% of the points provided to Terminal 2 (120), (i.e., 25 points).

The rate of provision of points based on the viewing of each advertisement and the rate of allocation of points provided to higher-layer terminals may vary depending on service providers or users.

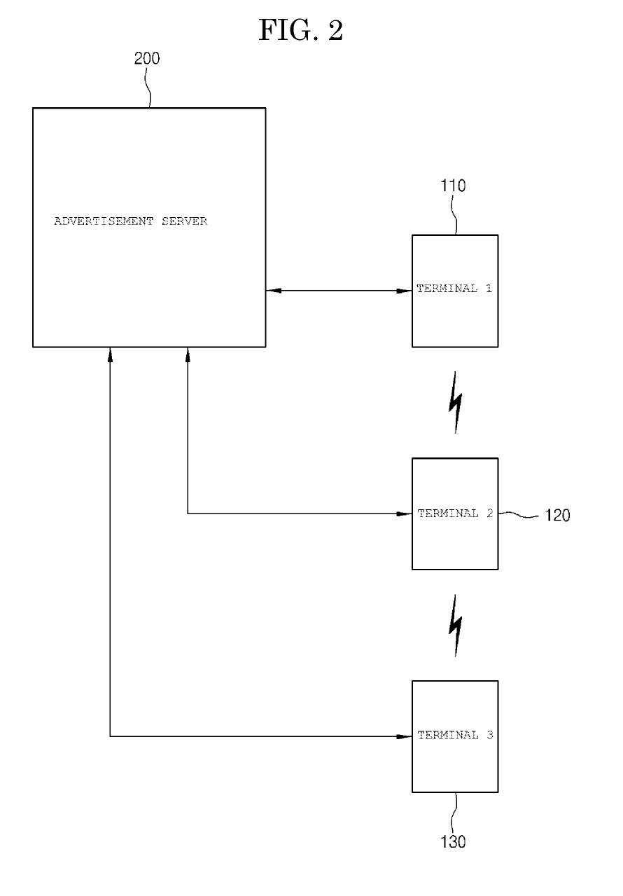

FIG. 2 is a diagram showing the notification of advertisement viewing information and point provisions between individual terminals and an advertisement server according to an embodiment of the present invention.

When Terminal 1 (110) is assumed to be the initial terminal that transmits an advertisement between terminals via short-range communication, Terminal 1 (110) receives the advertisement from an advertisement provision server. It is possible to receive the advertisement over a 3rd Generation (3G) network, or receive the advertisement through a medium in which the advertisement is stored.

After the received advertisement has been viewed on Terminal 1 (110), Terminal 1 (110) transmits advertisement viewing information, including its own terminal information, together with advertisement identification information, to an advertisement server (200). In this case, Terminal 1 (110) transmits the advertisement viewing information to the advertisement server (200) over the 3G network. Here, since Terminal 1 (110) did not receive the advertisement from a specific terminal, the advertisement viewing information transmitted from Terminal 1 (110) to the advertisement server 200 includes only advertisement identification information and its own terminal information. In this case, the advertisement identification information is information about the advertisement itself, and denotes information required to distinguish the corresponding advertisement from other advertisements. For example, advertisement identification information may be information about a company that advertises a product, the brand information of the company, product information, or the like. Here, its own terminal information denotes information required to identify the terminal. That is, terminal information is terminal identification information, and denotes the unique Identification (ID) information of the terminal, such as a phone number and a terminal serial number.

Terminal 2 (120) receives the advertisement from Terminal 1 (110) using a short-range communication scheme. After the received advertisement has been viewed on Terminal 2 (120), Terminal 2 (120) generates advertisement viewing information, including advertisement identification information, information about the terminal that provided the advertisement, and its own terminal information, and transmits the advertisement viewing information to the advertisement server (200). In this case, since Terminal 2 (120) received the advertisement from Terminal 1 (110), the terminal that provided the advertisement is Terminal 1 (110). Furthermore, its own terminal information is the terminal information of Terminal 2 (120). Therefore, Terminal 2 (120) transmits the advertisement identification information of the viewed advertisement, the terminal information of Terminal 1 (110), and the terminal information of Terminal 2 (120) to the advertisement server (200).

Terminal 3 (130) receives the advertisement from Terminal 2 (120) using a short-range communication scheme. Then, after the received advertisement has been viewed on Terminal 3 (130), Terminal 3 (130) generates advertisement viewing information, including advertisement identification information, the terminal information of Terminal 2 (120), and terminal information of Terminal 3 (130), and transmits the advertisement viewing information to the advertisement server (200).

Furthermore, when the advertisement server 200 receives the pieces of advertisement viewing information from the respective terminals, it analyzes the advertisement viewing information, calculates advertisement points to be allocated to the respective terminals, and provides the calculated advertisement points to the respective terminals. Furthermore, pieces of advertisement point information that are pieces of notification information about the allocated advertisement points are provided to the corresponding terminals. Here, the advertisement point information refers to advertisement points based on each viewed advertisement, cumulative advertisement points accumulated to date, etc. In this case, each terminal may check advertisement point information provided by the advertisement server 200 by executing a private program.

When the terminal is a smart phone, a private program may be downloaded and installed on the smart phone, and the above-described functions may be executed.

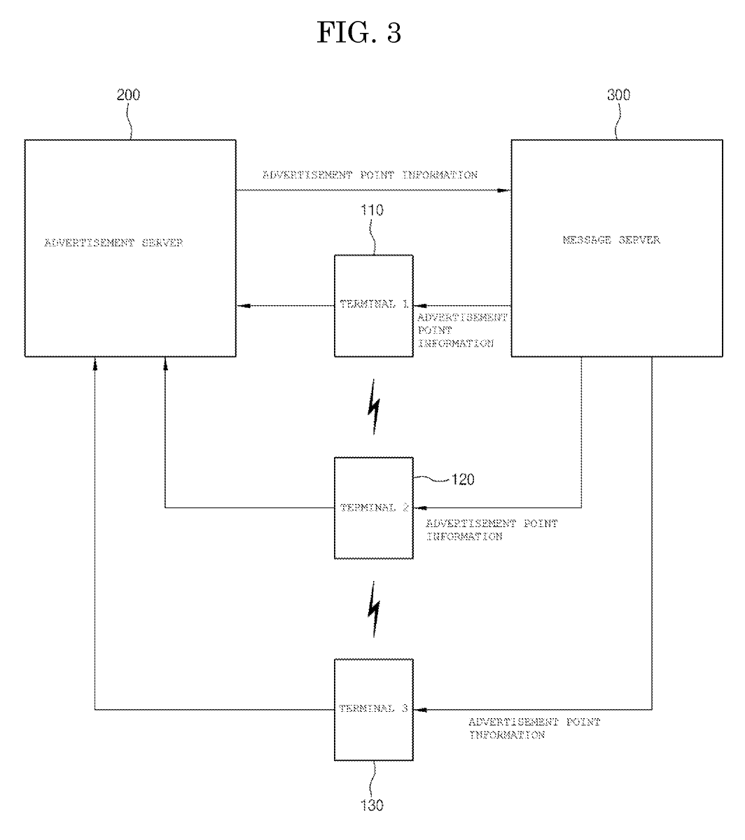

FIG. 3 is a diagram showing the provision of advertisement point information from a message server to individual terminals according to an embodiment of the present invention.

When a terminal is a feature phone, the advertisement server 200 cannot directly provide advertisement point information to each terminal, and it thus transmits the advertisement point information of each terminal to a message server 300. Then, the message server 300 sends a message including the received advertisement point information to the corresponding terminal.

For example, in FIG. 3, the message server 300 receives the advertisement point information of Terminal 1 (110), the advertisement point information of Terminal 2 (120), and the advertisement point information of Terminal 3 (130) from the advertisement server 200, and transmits the pieces of advertisement point information of the respective Terminals 110, 120, and 130 to the Terminals 110, 120, and 130 in the form of a text message or a multimedia message.

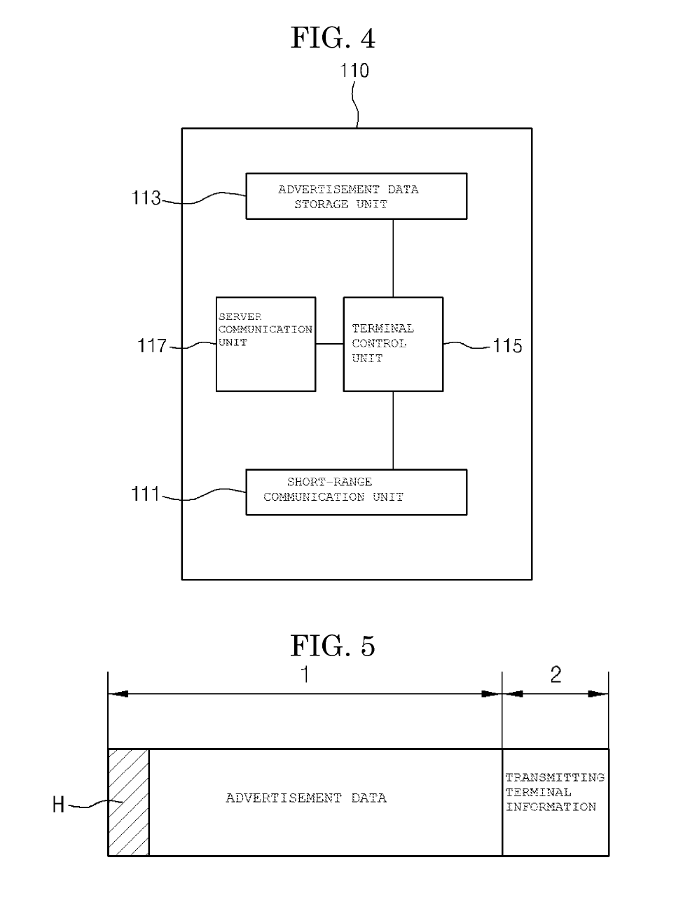

FIG. 4 is a diagram showing the configuration of a terminal according to an embodiment of the present invention.

The terminal 110 of the present invention includes a short-range communication unit 111, an advertisement data storage unit 113, a terminal control unit 115, and a server communication unit 117.

The short-range communication unit 111 transmits/receives data to/from other terminals using a short-range communication scheme. Here, the short-range communication unit 111 may use one or more of NFC, Bluetooth, Zigbee, and Ultra-wideband (UWB) communication schemes.

The advertisement data storage unit 113 stores advertisement data received from other terminals. The advertisement data storage unit 113 may be implemented as a storage medium, such as Random Access Memory (RAM) or Flash RAM.

The terminal control unit 115 performs a control function so that all functions of the terminal are executed in an integrated manner. Furthermore, the terminal control unit 115 executes the advertisement data stored in the advertisement data storage unit 113 so that the advertisement data can be used by a user. In particular, when advertisement data is transmitted to other terminals, the terminal control unit 115 performs control such that the advertisement data to be transmitted is processed to include its own terminal information and the resulting advertisement data is transmitted to the other terminals. If the terminal executes the received advertisement data in its entirety, that is, if a terminal user views the corresponding advertisement in its entirety, the terminal control unit 115 generates advertisement viewing information including advertisement identification information, the terminal information of an advertisement provision terminal, and its own terminal information. Thereafter, the terminal control unit 115 transmits the generated advertisement viewing information to the advertisement server 200. Here, the terminal control unit 115 prevents the corresponding advertisement from being skipped and partially played so that the user can entirely view the advertisement ranging from start to end. Furthermore, control is performed such that, only after the advertisement has been entirely played from start to end, the advertisement viewing information may be generated.

The server communication unit 117 communicates with the advertisement server 200. The server communication unit 117 may use a 3G communication scheme to communicate with the advertisement server 200. In addition, other communication schemes may also be used.

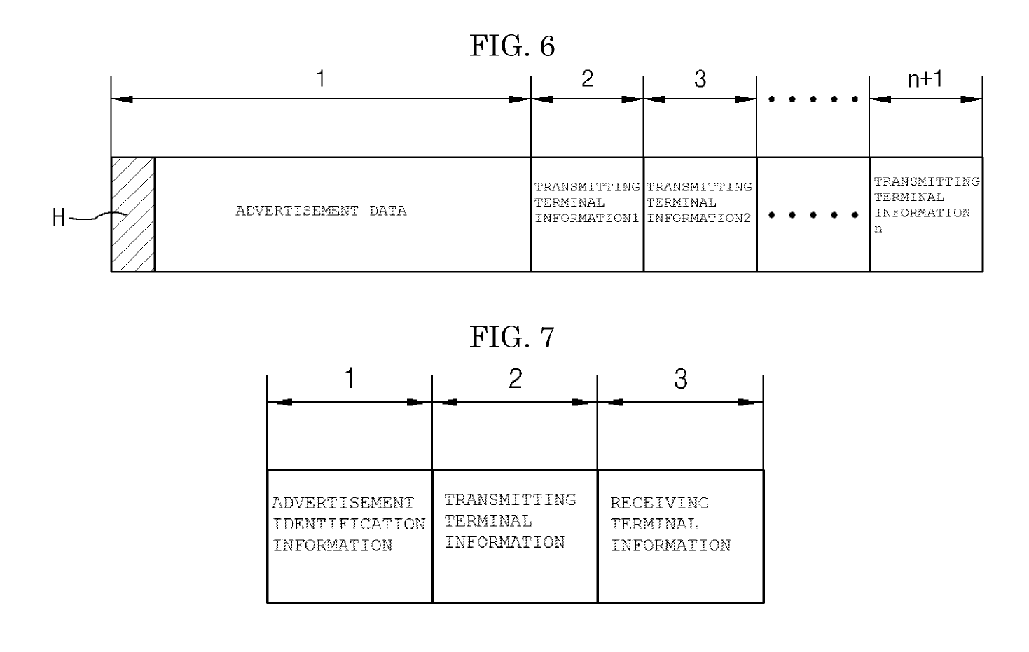

FIGS. 5 and 6 are diagrams showing the format of transmitted advertisement data when a terminal transmits the advertisement data to another terminal according to an embodiment of the present invention.

In the present invention, in order for a terminal on which an advertisement was viewed to transmit advertisement viewing information to the advertisement server, and for the advertisement server to provide advertisement points based on the viewing of the advertisement to each terminal, the terminal on which the advertisement was viewed must know information about a terminal which previously provided the corresponding advertisement.

Therefore, in the present invention, when advertisement data (1) is transmitted between terminals, a terminal which provides an advertisement transmits the advertisement data (1), after transmitting terminal information (2) which is its own terminal information, has been included in the advertisement data (1). As shown in FIG. 5, the transmitting terminal information (2) corresponding to the advertisement provision terminal information may be added to the tail part of the advertisement data (1) and may then be transmitted. FIG. 5 illustrates a state in which a terminal which directly provides the advertisement data (1) inserts only its own information into the advertisement data (1) and provides resulting advertisement data. FIG. 6 illustrates a state in which information about all terminals, which have previously provided the advertisement data, is included in the advertisement data.

That is, FIG. 5 illustrates a data format used when a terminal which provides advertisement data deletes information about previous transmitting terminals, adds only its own terminal information to the advertisement data, and provides resulting advertisement data. FIG. 6 illustrates a data format used when the advertisement data provision terminal adds its own terminal information to the advertisement data without deleting information about transmitting terminals, which previously provided the advertisement data, and transmits resulting advertisement data to another terminal. In FIG. 6, information about a terminal which initially transmitted the advertisement data (1) is included in transmitting terminal information 1 (2), and information about a terminal which secondly transmitted the advertisement data (1) is included in transmitting terminal information 2 (3). Information about a terminal that directly provided the advertisement data (1) is included in transmitting terminal information n (n+1).

In the present invention, an optimal data format may be selected and applied in consideration of the data processing capacity of the advertisement server, the data processing speed of the corresponding terminal, and the size of data to be transmitted to other terminals.

The header part H of the advertisement data (1) includes, information about an advertisement itself, and advertisement identification information required to distinguish the advertisement from other advertisements. Each terminal and the advertisement server (200) may identify the corresponding advertisement, based on advertisement identification information included in the header part H of the advertisement data.

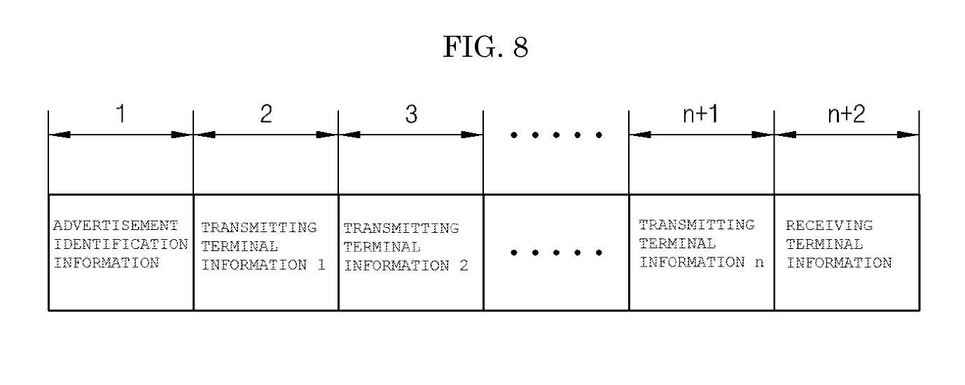

FIGS. 7 and 8 are diagrams showing the data format of advertisement viewing information transmitted from a terminal to an advertisement server according to an embodiment of the present invention.

FIG. 7 illustrates the data format of advertisement viewing information including advertisement identification information (1), transmitting terminal information (2), and receiving terminal information (3).

As described above with reference to FIG. 5, advertisement identification information (1) is information about an advertisement itself, included in the header part (H) of the advertisement data, and denotes information identification required to distinguish the advertisement from other advertisements. That is, when advertisement viewing information is transmitted to the advertisement server 200, the terminal configures advertisement viewing information using advertisement identification information included in the header part (H) of advertisement data.

Transmitting terminal information (2) denotes information about a terminal that directly provided advertisement data. This denotes transmitting terminal information described in FIG. 5.

Receiving terminal information (3) denotes information about a terminal itself on which the advertisement was viewed. That is, this information denotes the identification information of a terminal that transmits advertisement viewing information to the advertisement server 200 after the advertisement has been viewed.

FIG. 8 illustrates the data format of advertisement viewing information composed of advertisement identification information (1), transmitting terminal information (2), etc., transmitting terminal information n (n+1), and receiving terminal information (n+2). That is, FIG. 8 illustrates a data format in which the terminal information of all transmitting terminals that transmitted the advertisement data is included in the data format of the advertisement identification information shown in FIG. 7.

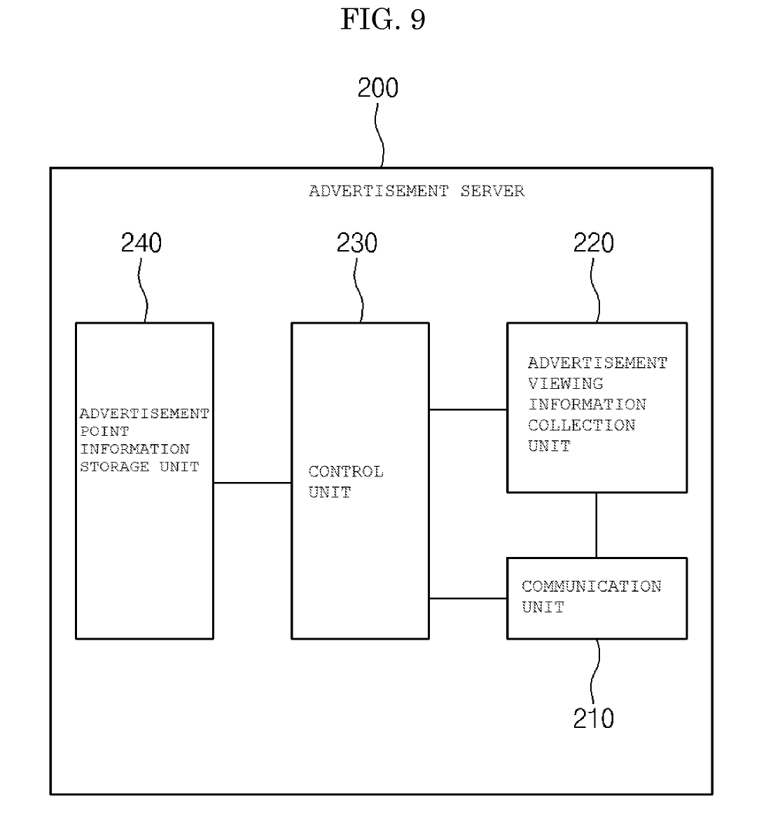

FIG. 9 is a diagram showing the configuration of an advertisement server according to an embodiment of the present invention.

The advertisement server 200 of the present invention includes a communication unit 210, an advertisement viewing information collection unit 220, a control unit 230, and an advertisement point information storage unit 240.

The communication unit 210 performs communication with individual terminals. That is, the communication unit 210 receives advertisement viewing information from the terminals, or provides advertisement point information to the terminals. For this operation, the communication unit 210 may be configured to include a 3G communication module.

The advertisement viewing information collection unit 220 functions to collect only advertisement viewing information from pieces of information received from individual terminals through the communication unit 210. That is, only advertisement identification information, transmitting terminal information, and receiving terminal information are selected from among the pieces of information received from the terminals and are provided to the control unit 230.

The control unit 230 allocates advertisement points based on the viewing of the corresponding advertisement to respective corresponding terminals using the advertisement identification information, the transmitting terminal information, and the receiving terminal information which are received from the advertisement viewing information collection unit 220, and upgrades pieces of advertisement point information of the respective terminals stored in the advertisement point information storage unit 240. Further, the control unit 230 provides the pieces of advertisement point information based on the viewing of the corresponding advertisement and pieces of upgraded cumulative advertisement point information to the respective terminals. The control unit 230 may directly provide the advertisement point information and the cumulative advertisement point information to the terminals, or may provide them to a message server 300 if the message server 300 is present.

The advertisement point information storage unit 240 stores advertisement types, information about advertisement points to be provided depending on the advertisement types, and information about advertisement points provided to the respective terminals depending on the types of viewed advertisements. For this, the advertisement point information storage unit 240 may be configured to further include a separate database (DB).

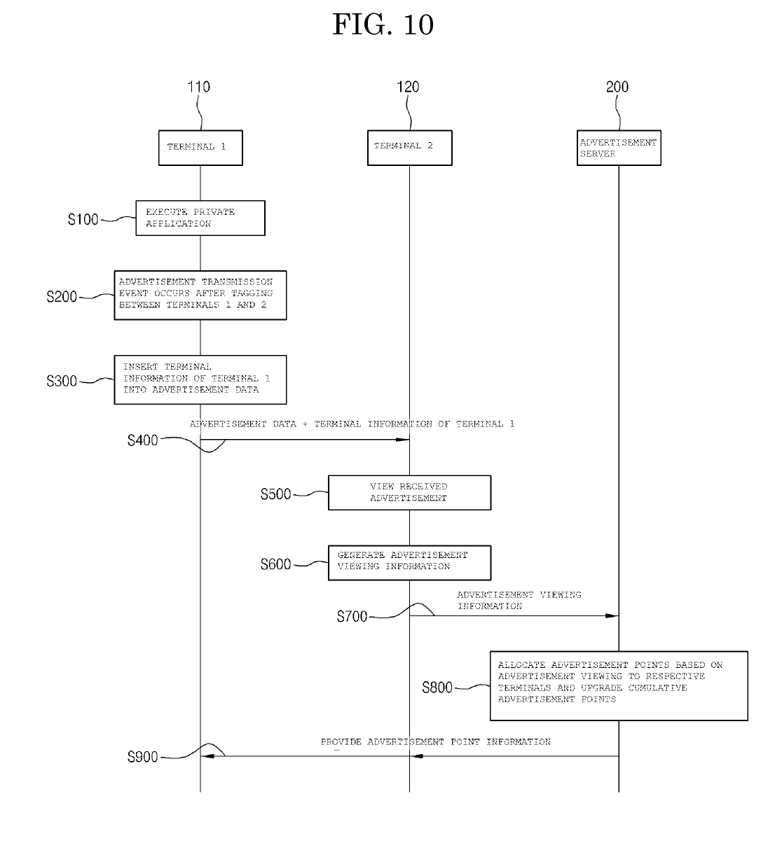

FIG. 10 is a diagram showing a method of providing an advertisement between terminals according to an embodiment of the present invention.

FIG. 10 will be described using an example in which the advertisement server 200 directly provides advertisement point information to each terminal. In this case, each terminal may be a smart phone.

For ease of description, it is assumed that Terminal 1 (110) is a transmitting terminal that transmits advertisement data, and Terminal 2 (120) is a receiving terminal that receives the advertisement data.

At step S100, the Terminal 1 (110) executes a private application for advertisement transmission/reception between terminals. After the private application has been executed, if tagging is performed between Terminal 1 (110) and Terminal 2 (120) at step S200, an advertisement reception event occurs on Terminal 2 (120), and then Terminal 2 (120) enters a mode in which advertisement data can be received. Before tagging with Terminal 1 (110), Terminal 2 (120) is in a sleep mode in which the consumption of power is minimized. Then, when Terminal 2 (120) tags with Terminal 1 (110) and an advertisement transmission event occurs, it switches the mode to a peer-to-peer mode in which advertisement data can be received using NFC.

At step S300, Terminal 1 (110) inserts its own terminal information into the advertisement data to be transmitted after tagging between Terminal 1 (110) and Terminal 2 (120) has been performed. As described above, in order to provide advertisement points based on the viewing of the advertisement to terminals on which the advertisement was viewed and to terminals that provided the advertisement, information about the advertisement provision terminals is required. Therefore, at step S300, Terminal 1 (110), which is an advertisement provision terminal, inserts its own terminal information into the advertisement data before transmitting the advertisement data.

In this case, Terminal 1 (110) may delete the terminal information of terminals which previously provided the advertisement data and insert only its own terminal information, or may add its own terminal information without deleting the terminal information of terminals that previously provided the advertisement data. In this case, the respective formats of the pieces of advertisement data have been described in FIG. 5.

In this case, step S300 Terminal 1 (110) inserting its own terminal information into the advertisement data to be transmitted may also be performed before step S200.

At step S400, Terminal 1 (110) transmits the advertisement data to Terminal 2 (120) after inserting its own terminal information into the advertisement data. The transmission of advertisement data between Terminal 1 (110) and Terminal 2 (120) is performed using NFC, as described above. In addition, the advertisement data may also be transmitted using a short-range communication scheme, such as Bluetooth, UWB, or Zigbee.

At step S500, the received advertisement data is viewed on Terminal 2 (120). Here, although the term “viewing” has been used because the advertisement data is assumed to be multimedia data containing an image, the advertisement data may be data composed of speech data or text.

At step S600, after the advertisement has been viewed, Terminal 2 (120) generates advertisement viewing information. The advertisement viewing information denotes information required by the advertisement server 200 to provide advertisement points to terminals based on the viewing of the corresponding advertisement. As described above with reference to FIG. 6, the advertisement viewing information is composed of advertisement identification information, transmitting terminal information, and receiving terminal information. After the advertisement has been viewed, Terminal 2 (120) extracts advertisement identification information and transmitting terminal information from the advertisement data, generates receiving terminal information which is its own terminal information, and then generates advertisement viewing information.

In this regard, the advertisement viewing information may include information about only the terminal that directly provided the advertisement, as described above in FIG. 7, and may also include information about all terminals that provided the advertisement data, as described above in FIG. 8.

At step S700, Terminal 2 (120) transmits the generated advertisement viewing information to the advertisement server 200. In this case, the advertisement viewing information is transmitted over a 3G network. Alternatively, the advertisement viewing information may also be transmitted over a data communication network such as a WiFi or Wibro network.

At step S800, the advertisement server 200 receives the advertisement viewing information, determines the type of advertisement using the received advertisement viewing information, calculates advertisement points to be provided in correspondence with advertisement viewing depending on each advertisement, and allocates the advertisement points to terminals on which the advertisement was viewed and to terminals that provided the advertisement, respectively. Furthermore, the cumulative advertisement points of the respective terminals are upgraded depending on the allocated advertisement points.

At step S900, the advertisement server 200 provides allocated or cumulative advertisement points to Terminal 1 (110) and to Terminal 2 (120). When the advertisement points are provided depending on the viewing of the advertisement, the advertisement server 200 provides to pieces of allocated advertisement point information to the respective terminals, the advertisement points of which are changed. Here, the advertisement point information includes advertisement points provided depending on each viewed advertisement and cumulative advertisement points. When a terminal is a smart phone, a private program may be executed and the advertisement point information received from the advertisement server 200 may be checked.

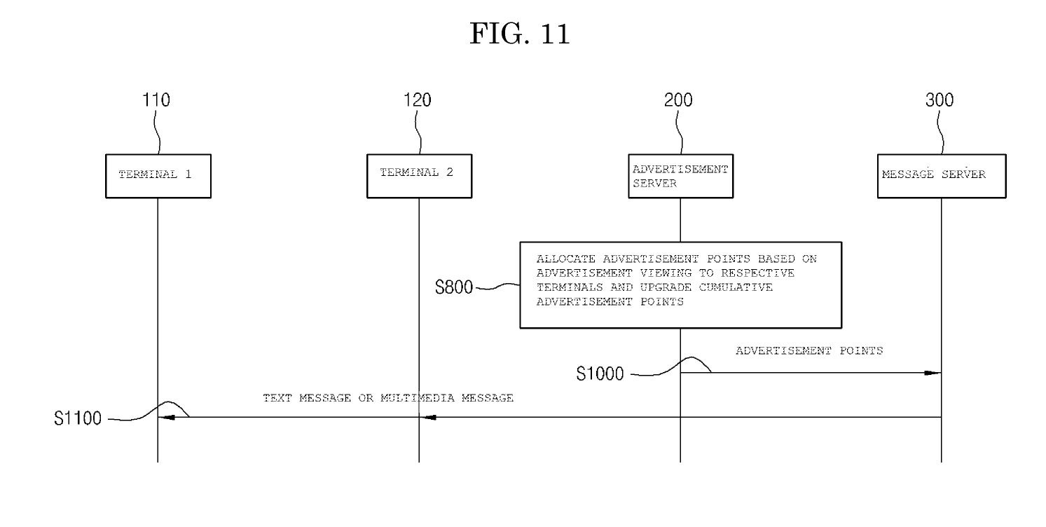

FIG. 11 is a diagram showing a method of providing advertisement point information from a message server to terminals according to an embodiment of the present invention.

When terminals are feature phones, a message server 300 is used to provide advertisement point information to the terminals. In FIG. 11, when terminals are feature phones, the message server 300 is further included, and a method of providing advertisement point information to the terminals will be described in detail.

At step S1000, the advertisement server 200 provides advertisement point information to the message server 300 after step S800 described in FIG. 10 has been performed. The advertisement server 200 transmits the advertisement points and cumulative advertisement points of respective terminals generated at step S800 to the message server 300.

At step S1100, the message server 300 provides the advertisement point information to the terminals. The message server 300 transmits the advertisement point information to the corresponding terminals in the form of a message on the basis of the information received from the advertisement server 200. Here, the message server 300 transmits advertisement point information to each terminal using a text message or a multimedia message.

Thereafter, each terminal may check the message received from the message server 300 and may then check advertisement points allocated thereto and the accumulative advertisement points.

Although the present invention has been described with reference to the embodiments of the present invention, those skilled in the art will appreciate that various modifications and changes are possible, without departing from the scope and spirit of the invention as disclosed in the accompanying claims.

In accordance with the present invention, there is an advantage in that advertisements are transmitted/received between terminals using a short-range communication scheme, thus providing advertisements effectively to potential consumers interested in products.

Furthermore, there is an advantage in that the advertisements are provided effectively only to specifically interested potential consumers, thus improving the advertising efficiency.

1. A terminal for providing an advertisement between terminals, comprising:
an advertisement data storage unit;
a short-range communication unit for transmitting/receiving advertisement data stored in the advertisement data storage unit to/from other terminals;
a server communication unit for communicating with an advertisement server; and
a terminal control unit for, when advertisement data is transmitted to other terminals, processing the advertisement data so that its own terminal information is included in the advertisement data, and for, when advertisement data is received and viewed, transmitting advertisement identification information, information about a terminal which transmitted the advertisement data, and its own terminal information to the advertisement server through the server communication unit after the advertisement has been viewed.

2. The terminal of claim 1, wherein the short-range communication unit uses one or more of Near Field Communication (NFC), Bluetooth, Zigbee, and Ultra-Wideband (UWB) communication schemes.

3. The terminal of claim 1, wherein when the terminal is a smart phone, the terminal directly receives advertisement point information from the advertisement server, whereas when the terminal is a feature phone, the terminal receives the advertisement point information from a message provision server in a form of a text message or a multimedia message.

4. A server for providing an advertisement between terminals, comprising:
a communication unit for communicating with terminals or a message server;
an advertisement viewing information collection unit for collecting advertisement viewing information from pieces of information received from the terminals;
an advertisement point information storage unit for storing pieces of advertisement point information of the respective terminals; and
a control unit for performing control such that the advertisement point information is upgraded using the advertisement viewing information collected by the advertisement viewing information collection unit and is stored in the advertisement point information storage unit, and such that the stored advertisement point information is transmitted to the terminals or the message server.

5. The server of claim 4, wherein the advertisement viewing information includes advertisement identification information, information about a terminal which provided the advertisement, and information about a terminal on which the advertisement was viewed.

6. The server of claim 5, wherein the advertisement point information storage unit stores cumulative advertisement points of respective terminals in the form of a table such that, for corresponding advertisement identification information, a terminal which provided an advertisement matches a terminal which received the advertisement and on which the advertisement was viewed.

7. A system for providing an advertisement between terminals, comprising:
a plurality of terminals for transmitting/receiving advertisement data between terminals using short-range communication, allowing an advertisement to be viewed, and transmitting advertisement viewing information to an advertisement server after the advertisement has been viewed; and
the advertisement server for receiving the advertisement viewing information from the terminals, analyzing the advertisement viewing information, and allocating advertisement points to respective terminals.

8. The system of claim 7, wherein each of the terminals is configured to, when the advertisement data is transmitted to a subsequent terminal, transmit the advertisement data after its own terminal information has been included in the advertisement data.

9. The system of claim 7, wherein the advertisement viewing information includes advertisement identification information, information about a terminal which provided the advertisement, and information about a terminal on which the advertisement was viewed.

10. The system of claim 7, wherein the advertisement server analyzes the advertisement viewing information, allocates advertisement points to the respective terminals, and provides advertisement point information to the terminals.

11. The system of claim 7, further comprising a message server for receiving the advertisement points from the advertisement server, and transmitting advertisement point information including the advertisement points to the terminals in a form of a text message or a multimedia message.
